(19) United States
(12) Patent Application Publication
(10) Pub. No.: US 2022/0096960 A1
(43) Pub. Date: Mar. 31, 2022

(54) METHOD AND SYSTEM FOR EXTRACTING AND RECOVERING SELECTIVE BIOACTIVE COMPONENTS FROM MITRAGYNA SPECIOSA PLANT BIOMASS

(71) Applicant: Alexander James Karp, San Diego, CA (US)

(72) Inventor: Alexander James Karp, San Diego, CA (US)

(21) Appl. No.: 17/036,340

(22) Filed: Sep. 29, 2020

(51) Int. Cl. B01D 11/02

(52) U.S. Cl. CPC B01D 11/0284; B01D 11/0215; B01D 11/0207; B01D 11/0203

(57) ABSTRACT

The present discloses a method and system for extracting and recovering selective bioactive components from Mitragyna speciosa plant biomass with carbon dioxide comprising one or more solutes in supercritical and/or subcritical state. The method and system disclosed herein comprise the steps; (i) contacting said Mitragyna speciosa plant biomass with carbon dioxide comprising one or more solutes in supercritical and/or subcritical state. (ii) further separating solution comprising said carbon dioxide, said solute(s) and said bioactive components from said plant biomass, (iii) further transitioning said solution comprising said carbon dioxide, said solute(s)s, and said bioactive components to solid phase, (iv) further removal of said carbon dioxide, and/or said solute(s) via sublimation and recovering said selective fraction of bioactive components consisting essentially of mitragyinien, paynanthine, speciogynine, and/or 7-Hydroxymitragynine.

### FIELD OF THE INVENTION

The present disclosure generally relates to a method of for extracting and recovering selective bioactive components from plant biomass with carbon dioxide comprising one or more solutes in supercritical and/or subcritical state. More specifically, this disclosure pertains to methods and systems for the selective extraction and recovery of desirable alkaloids from Mitragyna speciosa plant parts.

### BACKGROUND

Phytochemicals are chemical compounds that occur naturally in plants. Some phytochemicals are bioactive in humans and are used in nutraceutical products that are generally sold in medicinal forms. The current common approach to the extraction of plant components is through use of either organic solvents or unpressurized hot water to solubilize and remove phytochemicals from plant biomass. The organic solvent systems commonly use one or more of ethanol, methanol, ethyl acetate and acetone in relatively large and therefore costly amounts. It is well-known that hot-water systems tend to be less efficient than organic solvent-based systems and are able to only extract a portion of the potentially available phytochemicals from the plant biomass.

Attempts to address the limitations in the above extraction techniques have been made through the use of heated and pressurized aqueous solvent solutions referred to as pressurized low polarity water (PLPW) apparatus and systems. These systems often use relatively large amounts of aqueous solution producing relatively low concentration of desired alkaloid fractions. Additionally, typical temperatures utilized in PLPW apparatus and systems often exceed the temperature at which the desired bioactive phytochemicals degrade.

Many extraction systems produce a mixture comprising desired phytochemicals and the solvent used for extraction. It is well known to employ reduced pressure evaporation to recover solvent for future extraction. Some systems employ secondary processing, such as freeze-drying or lyophilization to completely remove liquid solvent providing the advantages of weight reduction and stability of bioactive components in dry form.

Conversely to extraction and recovery systems, various coffee decaffeination methods are well-known in the art wherein a method or system is employed for the selective removal and discarding of undesirable phytochemicals such as caffeine. One such technique is the use of a supercritical fluid, preferably supercritical carbon dioxide, to extract the caffeine from green coffee beans. Such a technique is disclosed in U.S. Pat. No. 4,260,639 to Mosel wherein green coffee is contacted with water-moist supercritical carbon dioxide in order to extract the caffeine and recover a substantially decaffeinated coffee.

### SUMMARY OF THE INVENTION

The embodiments of the present disclosure generally relate to a methods and systems for extracting and recovering bioactive components from Mitragyna speciosa plant biomass with carbon dioxide in supercritical and/or subcritical state comprising combinations of one or more organic solutes and/or one or more inorganic solutes.

Mitragyna speciosa plant biomass contain various bioactive phytochemicals and/or components. These phytochemicals and components are typically found in relatively low concentrations relative to the total plant biomass. Additionally, moderate therapeutic amounts of said phytochemicals and/or components therefore require significant plant biomass quantities. It is therefore advantageous to be able to selectively separate bioactive phytochemicals and/or components from the Mitragyna speciosa plant biomass.

The method and system generally comprises the steps of:

(i) contacting said Mitragyna speciosa plant biomass with carbon dioxide comprising one or more solutes in supercritical and/or subcritical state, (ii) further separating solution comprising said carbon dioxide, said solute(s) and said bioactive components from said plant biomass, (iii) further transitioning solution consisting essentially said carbon dioxide, said solute(s)s, and said bioactive components to solid phase, (iv) further removal of said carbon dioxide, and/or said solute(s) via sublimation and recovering a selective fraction of bioactive components consisting essentially of Mitragynine, Paynantheine, Speciogynine, and/or 7-Hydroxymitragynine.

The method and system of the present disclosure requires less solvent and produce a more selectively desirable extract than prior art processes and systems. Additionally, compared to prior art, the method and system of the present disclosure operate at temperatures substantially below the degradation temperature of the desirable phytochemicals to be extracted. Further, the method and system of the present disclosure produces a dray and stable extract product consistent with lyophilization.

### BRIEF DESCRIPTION OF THE DRAWINGS

Various other objects, features, and attendant advantages of the present invention will be more fully appreciated from the following detailed description when considered in connection with the accompanying drawings in which like reference characters designate like or corresponding parts throughout the several views, and wherein:

FIG. 1 shows a flow diagram for one method embodiment of the disclosure for extracting and recovering selective bioactive components from Mitragyna speciosa plant biomass with carbon dioxide comprising one or more co-solutes in supercritical and/or subcritical state;

FIG. 2 shows a cycle system diagram for one system embodiment of the disclosure for extracting and recovering selective bioactive components from Mitragyna speciosa plant biomass with carbon dioxide comprising one or more co-solutes in supercritical and/or subcritical state;

### DETAILED DESCRIPTION

A detailed description of the hereinafter described embodiments of the disclosed apparatus are presented herein by way of exemplification and not limitation with reference to the Figures. Although certain embodiments are shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of embodiments of the present invention.

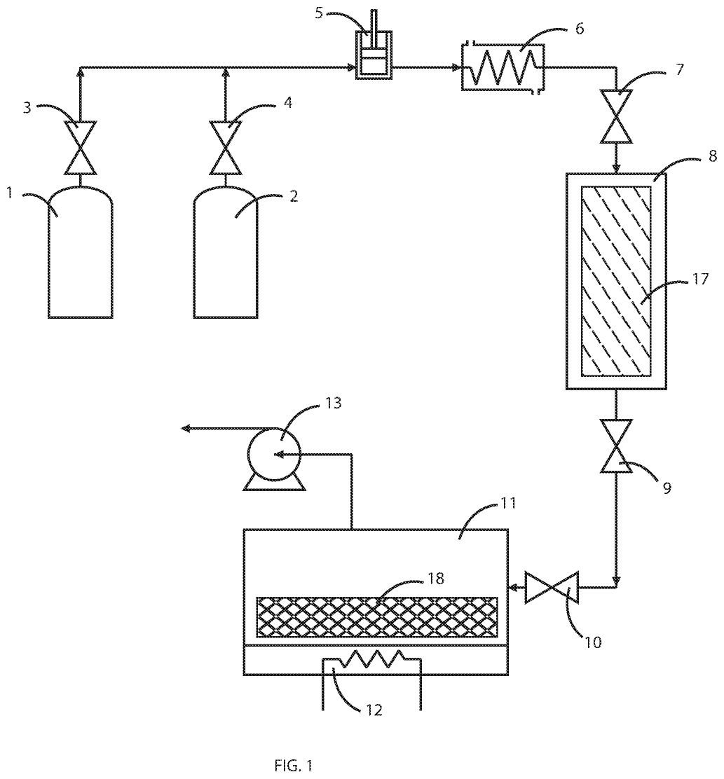

With reference to FIG. 1, a flow from container 1 housing one or more organic solutes and/or one or more inorganic solutes, operatively connected to a flow control valve 3; a flow from container 2 housing compressed carbon dioxide, operatively connected to a flow control valve 4, such that flow control valve 3 and flow control valve 4 are capable of maintaining optimal flow ratio of solutes to a high pressure pump 5; where high pressure pump 5 is operatively connected to a heat exchanger 6 and operatively connected to a flow control valve 7 such that carbon dioxide comprising one or more solutes is maintained in supercritical and/or subcritical state; further, control valve 7 is operatively connected to extraction container 8 housing Mitragyna speciosa plant biomass 17, which is operatively connected to control valve 9 such that contact is maintained between said Mitragyna speciosa plant biomass 17 with said carbon dioxide comprising one or more solutes in supercritical and/or subcritical state; further control valve 9 is operatively connected to flow control valve 10 such that said carbon dioxide comprising one or more solutes and solubilized bioactive components flow to vacuum chamber 11, where said carbon dioxide comprising one or more solutes and solubilized bioactive components transition to solid state 18; further vacuum chamber 11 with a heating element 12 housed within is operatively connected to a vacuum pump 13 such that heating element 12 provides energy into solid carbon dioxide comprising one or more solutes and solubilized bioactive components and vacuum pump 13 maintains a vacuum in vacuum chamber 11 where solid carbon dioxide comprising one or more solutes sublimates and exits vacuum pump 13, thereby bioactive components consisting essentially of Mitragynine, Paynantheine, Speciogynine, and/or 7-Hydroxymitragynine are collected and recovered in vacuum chamber 11.

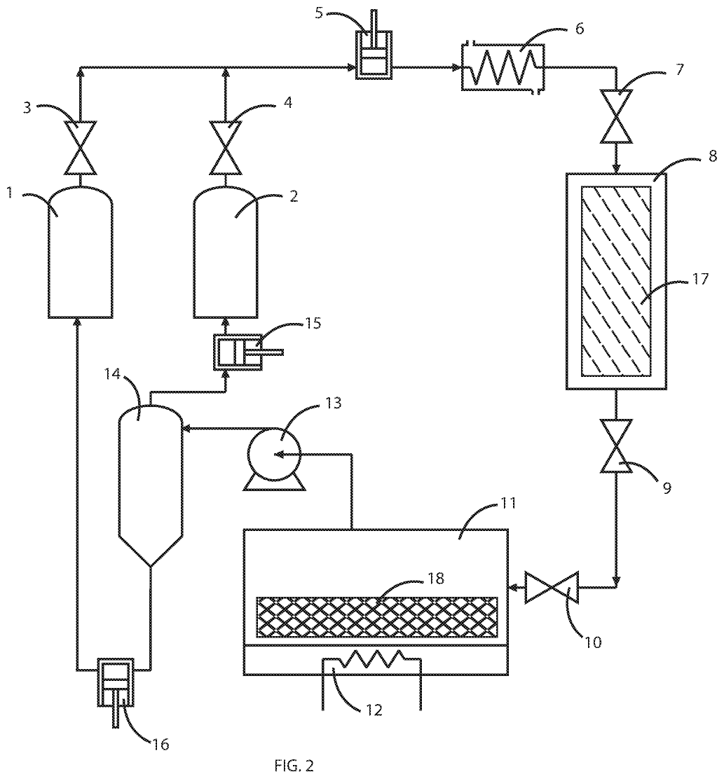

With reference to FIG. 2, a system capable of maintaining flow described in FIG. 1; further vacuum pump 13 is operatively connected to a separation tank 14, such that carbon dioxide comprising one or more solutes condenses and separates based on density differences between said carbon dioxide and said solutes; further separation tank 14 is operatively connected to a compressor pump 15, with compressor pump 15 being operatively connected to container 2 such that carbon dioxide is moved from separation tank 14 to container 2; further separation tank 14 is operatively connected to a pump 16, with pump 16 being operatively connected to container 1 such that said solutes are moved from separation tank 14 to container 1.

What is claimed:

1. A method for the extracting and recovering phytochemicals and/or components from Mitragyna speciosa plant biomass which comprises contacting said Mitragyna speciosa plant biomass with carbon dioxide in supercritical and/or subcritical state to effect removal of phytochemicals and/or components from said Mitragyna speciosa plant biomass therefrom and recovering a selective fraction of phytochemicals and/ components.

2. A method of claim 1) where said carbon dioxide comprises one or more organic solutes and/or one or more inorganic solutes,

3. A method of claim 1) wherein the carbon dioxide and/or solutes containing phytochemicals and/or components are further transitioned to solid state to effect removal of carbon dioxide and/or solutes via sublimation.

4. A method of claim 1) wherein said selective fraction of said phytochemicals and/or components consist essentially Mitragynine, Paynantheine, Speciogynine, and/or 7-Hydroxymitragynine.

5. A system capable of extracting and recovering phytochemicals and/or components from Mitragyna speciosa plant biomass which comprises contacting the Mitragyna speciosa plant biomass with carbon dioxide in supercritical and/or subcritical state to effect removal of phytochemicals and/or components from the Mitragyna speciosa plant biomass therefrom and recovering a selective fraction of phytochemicals and/components.

6. A system of claim 5) where carbon dioxide comprises one or more organic solutes and/or one or more inorganic solutes,

7. A system of claim 5) wherein the carbon dioxide and/or solutes containing phytochemicals and/or components are further transitioned to solid state to effect removal of carbon dioxide and/or solutes via sublimation,

8. A system of claim 5) wherein said selective fraction of said phytochemicals and/or components consist essentially Mitragynine, Paynantheine, Speciogynine, and/or 7-Hydroxymitragynine.
